(19) United States
(12) Patent Application Publication
(10) Pub. No.: US 2008/0238895 A1
(43) Pub. Date: Oct. 2, 2008

(54) Driving Device of Display Device and Related Method

(76) Inventors: Jin-Ho Lin, Kao-Hsiung City (TW); Che-Li Lin, Taipei City (TW); Wen-Chi Lin, Yilan County (TW); Wen-Yuan Tsao, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 11/971,921

(22) Filed: Jan. 10, 2008

(30) Foreign Application Priority Data
Mar. 29, 2007 (TW) 096111025

(51) Int. Cl. G06F 3/038

(52) U.S. Cl. 345/204

(57) ABSTRACT

In order to increase charge time of thin-film transistor (TFT) cells of a display device, the present invention provides a driving device, which includes a timing controller, a column driver module and at least a delay module. The timing controller is used for outputting at least a load signal. The column driver module is coupled to the timing controller and includes at least a column driver. The delay module can be installed in the column driver module or the timing controller, and is used for delaying the load signal for a predetermined time. The load signal is utilized to trigger the plurality of column drivers to output video data provided by a video data source and the video data corresponds to pixels on a panel of the display device. The driving device can use in a cascading, point-to-point or bus-type interfacing architecture to transmit the load signal.

### BACKGROUND OF THE INVENTION

1. Field of the Invention

The present invention relates to a driving device of a display device and related method, and more particularly to a driving device of a display device for delaying a load signal and related method.

2. Description of the Prior Art

A liquid crystal display (LCD) device is a flat panel display (FPD) characterized by thin appearance, low radiation and low power consumption. The LCD device has gradually replaced a traditional cathode ray tube (CRT) display, and is widely applied in various electronic products such as a notebook computer, a personal digital assistant (PDA), a flat panel television, and a mobile phone. Common FPD devices include thin-film transistor liquid crystal display (TFT-LCD) devices, low temperature poly silicon liquid crystal display (LTPS-LCD) devices, and organic light emitting diode (OLED) display devices.

The LCD device includes a liquid crystal panel, a timing controller, column drivers, and row drivers. There are parallel data lines and parallel scan lines arranged on the liquid crystal panel. The data lines and scan lines form intersections each having a corresponding thin film transistor cell, called TFT cell hereinafter. That is, the liquid crystal panel includes a TFT cell matrix. The column drivers utilize the data lines to transfer video data for the TFT cells, and the row drivers utilize the scan lines to turn on or off the TFT cells. There is a transmission interface used between the timing controller and the column drivers to transmit data, control, clock and other related signals. In the available LCD devices, typical interfaces used in an LCD device include transistor-transistor logic (TTL) interfaces, reduced swing differential signal (RSDS) interfaces, and mini low voltage differential signal (mini-LVDS) interfaces, etc. Irrespective of any above-mentioned interfaces, setup and hold time should have a specific relationship between the data, control and clock signals, in order for the column drivers to receive data and generate source driving signals, accurately.

The LCD device utilizes the timing controller to generate data signals with respect to the video data, control and clock signals required to drive the panel. The column drivers, or the source drivers, perform logic operations for the data signals according to the control and clock signals so as to generate driving signals. The row drivers, or the gate drivers, output row scan signals row-by-row to turn on each TFT cell of the panel. The source driving signals output the video data to TFT cells according to the time that the row drivers turn on the TFT cells. Furthermore, the video data is a set of groups of pixel data, where each group of pixel data includes red, blue and green color data. For the column drivers, each color data corresponds to an output channel. For example, there is a panel having a resolution of 1366×768 and every column driver is responsible for 420 output channels. As a result, the display device requires ten column drivers to drive the pixels of the panel. In the LCD devices, the row scan signals generally have delay effect due to RC loading effect on the scan lines. The TFT cells far from the row drivers are therefore turned on and off later than the default time. As the TFT cells close to the row drivers have been turned off but those far from the row drivers are still on due to delay of the row scan signals, the far ones may charge to a wrong voltage level. In the prior art, one of solutions is to pull low the row scan signals earlier as well as to turn off the TFT cells of each row earlier. However, for large-panel and high-resolution applications, charge time for each scan line becomes shorter such that traditional solution may cause insufficient charge time for the TFT cells.

With a trend of large-sized panels and high-resolution requirement, the number of column drivers and size of the signal transmission medium, such as printed circuit board (PCB) increase accordingly. Transmission path between the timing controller and the column drivers becomes longer as well.

Please refer to FIG. 1, which is a schematic diagram of a display device 10 according to the prior art. The display device 10 includes a timing controller 100, column drivers CD₁-CD_{N}, row drivers 110 and a panel 120. The timing controller 100 transmits a load signal S_{LOAD} to the column drivers CD₁-CD_{N} with a bus-type interface. The load signal S_{LOAD} is utilized to trigger the column drivers CD₁-CD_{N} to output video data, and the column drivers CD₁-CD_{N} share the load signal S_{LOAD}. In this situation, the column drivers CD₁-CD_{N} sequentially output the driving signals to charge corresponding TFT cells to a predetermined voltage level. Furthermore, according to the load signal S_{LOAD}, the time the column drivers CD₁-CD_{N} output the driving signal to fit the time the row driver turns on the corresponding TFT cells to allow the TFT cells to has enough time to charge. In the prior art, the load signal S_{LOAD} is directly sent to the column drivers without any signal processes. Besides, the bus-type transmission manner of the load signal S_{LOAD} in the display device 10 is commonly employed in an RSDS or mini-LVDS interfacing architecture.

Please refer to FIG. 2, which is a diagram of signal timing of the display device 10 according to the prior art. Assume that the display device 10 has a 32-inch panel, resolution of 1366×768, and column drivers CD₁-CD₁₀ each responsible for 420 output channels. Further, a frame rate is set to 60 frames per second. Charge time for each scan line is about 15 μs, and row scan signal needs about 2 μs to travel from the first output channel of the column driver CD₁ to the last output channel of the column driver CD₁₀. From top to bottom, signals in FIG. 2 are the load signal S_{LOAD}, an output signal of the column driver, the row scan signal related to the first output channel CH₁ of the column driver CD₁. By analogizing the above, the last signal is the row scan signal related to the 420^{th} output channel CH₄₂₀ of the column driver CD₁₀. In FIG. 2, as the row scan signal turns on the TFT cell corresponding to the output channel CH₁ of the column driver CD₁, the load signal S_{LOAD} triggers the column driver CD₁ to output video data to the TFT cell and then triggers the column drivers CD₂-CD₁₀ in sequence to do the same. As shown in FIG. 2, a first pulse of the load signal S_{LOAD} exactly falls on a rising edge of the output channel CH₁ of the column driver CD₁, whereas the next pulse of the load signal S_{LOAD} falls on a falling edge of the output channel CH₄₂₀ of the column driver CD₁₀. The row scan signal with respect to each output channel has to pull low as well as to turn off the TFT cell for at least 2 μs due to a required time of 2 μs to finish a row scanning. This prevents insufficient charge of the TFT cells but reduces a total period allocated to charge the TFT cells of a row.

In the prior art, the display device transmits the load signal in the bus-type manner, and the load signal carries no information including delay component. In other words, all the column drivers of the display device share the load signal and the load signal is just directly sent to the column drivers. In this situation, the row scan signal related to each output channel has to pull low for the scanning time of a row, which may cause poor charge efficiency to the TFT cells. Especially in the LCD devices with large-size panels, the row scan signal requires more traveling time and therefore the TFT cells needs to be turned off earlier, which is liable to causing inaccurate charge. Thus, the prior art has restriction on allocation of the charge times for the TFT cells.

### SUMMARY OF THE INVENTION

It is therefore a primary object of the present invention to provide a driving device for delaying a load signal in a cascading, bus-type or point-to-point manner and related method that can provide sufficient charge time for TFT cells.

The present invention discloses a driving device of a display device, which includes a timing controller, a column driver module and at least a delay module. The timing controller is used for outputting at least a load signal. The column driver module is coupled to the timing controller. The delay module is used for delaying the load signal for a predetermined time. The load signal is utilized to trigger the plurality of column drivers to output video data provided by a video data source and the video data corresponds to pixels on a panel of the display device.

The present invention further discloses a driving method for a display device. The driving method includes the following steps. At least a load signal is transmitted from a timing controller to a column driver module. The load signal is delayed for a predetermined time. The driving method can use in a cascading, point-to-point or bus-type interfacing architecture to transmit the load signal.

The present invention further discloses a column driver for a display device, comprising an input terminal, a delay module and a video data processing unit. The input terminal is used for receiving a load signal. The delay module is coupled to the input terminal and used for delaying the load signal for a predetermined time. The video data processing unit is coupled to the delay module, and used for processing video data, provided by a video data source, and outputting the processed video data to pixels on a panel of the display device according to timing of the load signal outputted from the delay module.

The present invention further discloses a timing controller of a display device. The timing controller includes at least a delay module and an output unit. The delay module is used for delaying a load signal for a predetermined time. The output unit is used for outputting the delayed load signal to at least a column driver. The load signal is utilized to trigger the column driver to output the video data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to the prior art.

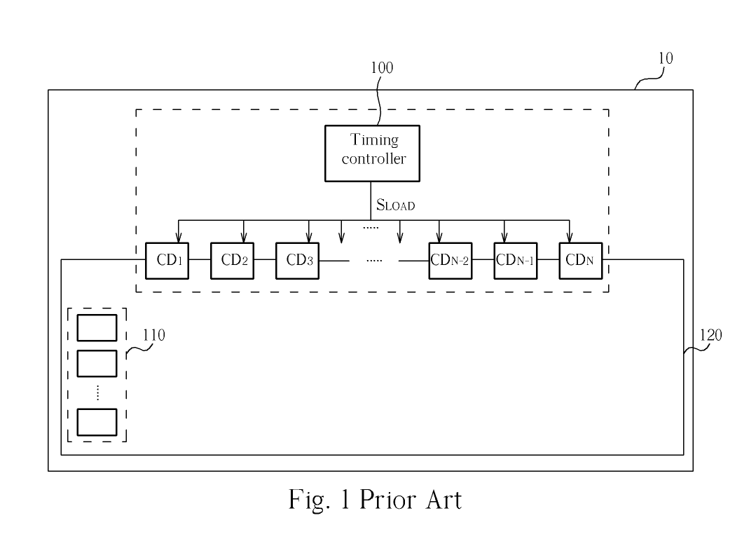

FIG. 2 is a diagram of signal timing of the display device according to FIG. 1.

FIG. 3 is a schematic diagram of a driving device of a display device according to an embodiment of the present invention.

FIG. 4 is a schematic diagram of a column driver according to an embodiment of the present invention.

FIG. 5 is a schematic diagram of the delay controller according to FIG. 4.

FIG. 6 is a schematic diagram of the column driver according to an embodiment of the present invention.

FIG. 7 is a schematic diagram of the delay controller according to FIG. 6.

FIG. 8 is a timing diagram of signals corresponding to the column drivers and the row drivers according to FIG. 3 and FIG. 4.

FIG. 9 is a timing diagram of signals corresponding to the column drivers and the row drivers according to FIG. 3 and FIG. 6.

FIG. 10 is a flowchart of a process according to an embodiment of the present invention.

FIG. 11 is a schematic diagram of a driving device of a display device according to an embodiment of the present invention.

### DETAILED DESCRIPTION

The main concept of the present invention is, for a display device, embedding delay information into a load signal outputted from a timing controller to a column driver side. The delay information can be generated at the column driver side or the timing controller side, depended on the transmission architecture corresponding to the load signal.

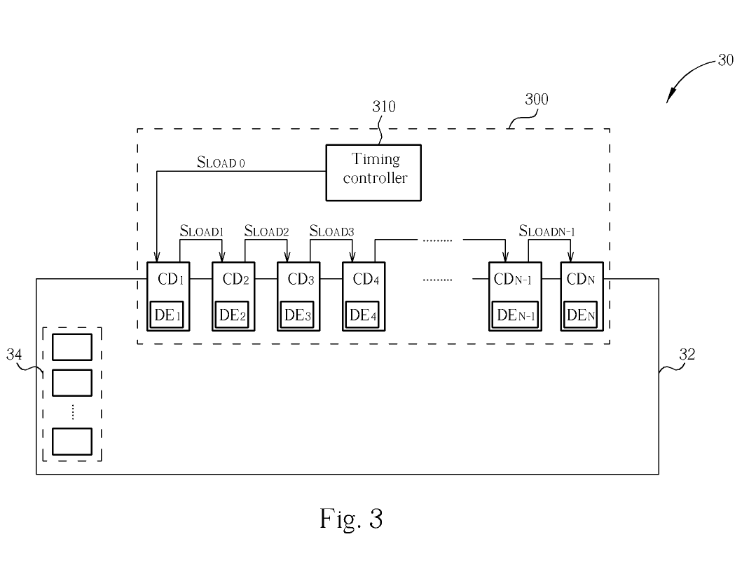

Please refer to FIG. 3, which is a schematic diagram of a driving device 300 of a display device 30 according to an embodiment of the present invention. Besides the driving device 300, the display device 30 includes a panel 32 and multiple row drivers 34. The driving device 300 includes a timing controller 310 and column drivers CD₁-CD_{N}. The timing controller 310 is used for outputting a load signal S_{LOAD0} utilized to output the column drivers CD₁-CD_{N} to output video data provided by an video data source to thin film transistor cells (called TFT cells hereinafter) of the panel 32. The video data is commonly red, green and blue data, which is also well known as RGB data. The column drivers CD₁-CD_{N} are used for transmitting the load signal S_{LOAD0} in a cascading manner. The column drivers CD₁-CD_{N} includes delay modules DE₁-DE_{N}, respectively. The delay modules DE₁-DE_{N} are used for receiving the load signal, delaying timing of the received load signal for a predetermined time and then outputting the delayed load signal to the next column driver. As can be seen in FIG. 3, the column driver CD₁ has a shorter distance from the row drivers 34 than the column drivers CD₂-CD_{N} do. Only the column driver CD₁ is coupled to the timing controller 310 and thereby receives the load signal S_{LOAD0} outputted by the timing controller 310. The delay module DE₁ of the column driver CD₁ delays timing of the load signal S_{LOAD0}, and then outputs a load signal S_{LOAD1} to the column driver CD₂. By the same operation, the delay module DE₂ delays timing of the load signal S_{LOAD1}, and then outputs a load signal S_{LOAD2} to the column driver CD₃. By analogizing the delay modules DE₁ and DE₂ to the others, the delay module DE_{N-1} delays timing of the load signal S_{LOADN-2}, and then outputs a load signal S_{LOADN-1} to the column driver CD_{N}. The embodiment of the present invention transmits the load signal through the column drivers in a cascading manner, and thereby each delay module delays timing of the load signal according to the predetermined time. Thus, the load signal transmitted through every column driver can match timing of driving the TFT cells by the row drivers.

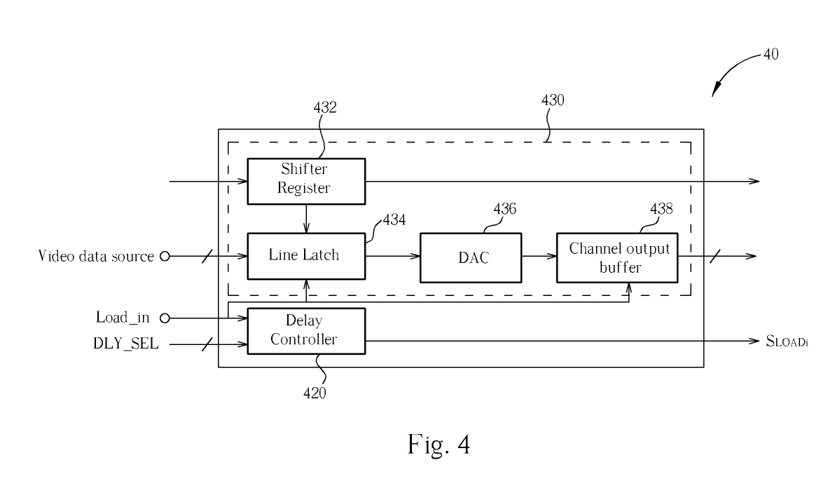

Please refer to FIG. 4, which is a schematic diagram of the column driver 40 according to an embodiment of the present invention. The column driver 40 is utilized to realize each of the column drivers CD₁-CD_{N} in FIG. 3, and includes a delay controller 420 and a video data processing unit 430. The delay controller 420 is an embodiment for the delay modules DE₁-DE_{N} of FIG. 3 and receives a load signal S_{LOADi-1} with a receiving terminal Load_in, delays timing of the load signal S_{LOADi-1} for the predetermined time according to a control signal DLY_SEL, and then outputs a load signal S_{LOADi}, where i=1−N. The video data processing unit 430 is coupled to the delay controller 420 and used for processing the video data to output to corresponding pixels as well as the TFT cells according to timing of the load signal outputted by the delay controller 420. The video data processing unit 430 includes a shifter register 432, a line latch 434, a digital-to-analog converter (DAC) 436 and a channel output buffer 438. The shifter register 432 is coupled to the timing controller 310, and is utilized to receive a startup signal generated by the timing controller 310. The line latch 434 is coupled to the shifter register 432, the delay controller 420 and the video data source, and is utilized to process video data provided by the Video data source according to timings of a signal outputted by the shifter register 432 and the load signal S_{LOADi-1} outputted by the delay controller 420. The DAC 436 is coupled to the line latch 434, and is utilized to convert signals outputted by the line latch 434 from digital into analog form. The channel output buffer 438 is coupled to the DAC 436 and the delay controller 420, and is utilized to output analog video data which is a result of processing output signals of the DAC 436 to the TFT cells of the panel 32 according to timing of the load signal S_{LOADi-1}.

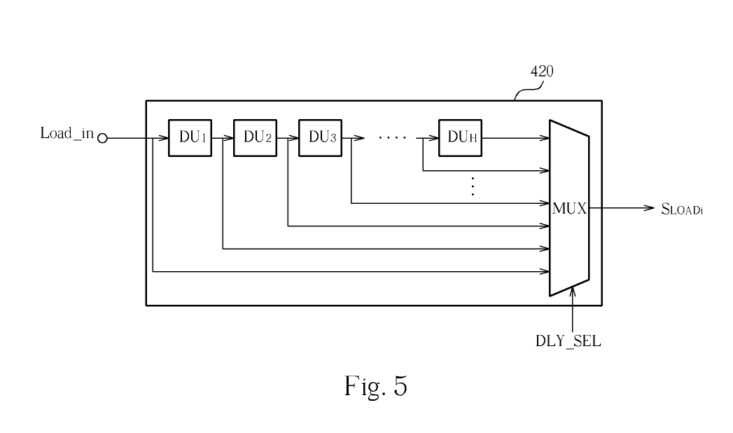

Please refer to FIG. 5, which is a schematic diagram of the delay controller 420 according to FIG. 4. The delay controller 420 includes a receiving terminal Load_in, delay units DU₁-DU_{H} and a multiplexer MUX. The receiving terminal Load_in is utilized to receive the load signal S_{LOADi-1}. The delay units DU₁-DU_{H} are coupled in cascade and the delay unit DU₁ is coupled to the receiving terminal Load_in. The delay units DU₁-DU_{H} is used for delaying timing of signals received. The multiplexer MUX is coupled to the receiving terminal Load_in and each output terminal of the delay units DU₁-DU_{H}, and used for determining the predetermined time used for the load signal S_{LOADi-1} according to the control signal DLY_SEL, where i=1−N.

Regarding cascading transmission for the load signal S_{LOAD0}, the load signal S_{LOAD0} outputted by the timing controller 310 is first transmitted to the column driver CD₁. As the column driver CD₁ receives the load signal S_{LOAD0}, the load signal S_{LOAD0} passes through the delay controller 420 installed inside the column driver CD₁. The delay units DU₁-DU_{H} in the delay controller 420 individually delays timing of the load signal, such as the load signals S_{LOAD0} and S_{LOAD1}, and thereby generate multiple delayed load signals. The load signal received by the receiving terminal and the delayed load signals are jointly inputted to the multiplexer MUX, and thereby the multiplexer MUX selects one from the inputted load signals according to the control signal DLY_SEL indicating the predetermined time. After load signal selection, the multiplexer MUX simultaneously outputs the load signal S_{LOAD1} to the line latch 434 and the channel output buffer 438 of the column driver CD₁ and also the column driver CD₂. By similar operation, the load signal S_{LOAD1} passes through the delay controller 320 inside the column driver CD₂ and is delayed. The load signal S_{LOAD2} is then transmitted to the line latch 434 and the channel output buffer 438 of the column driver CD₂ and outputted to the column driver CD₃. As can be analogized the above, the load signal S_{LOAD} is transmitted through each the column driver and delayed stage-by-stage. Thus, the driving device 300 transmits the load signal S_{LOAD0} in a cascading manner and the column drivers can delay the load signal by themselves. Besides, the column drivers in the embodiment of the present invention have a delay controller which can produce multiple delays for the load signal, and a expected delayed load signal can be easily selected via an external control signal. Therefore, this eliminates the need for the row drivers to sacrifice turn-on time of the TFT cells, and thereby increases charge efficiency of the TFT cells.

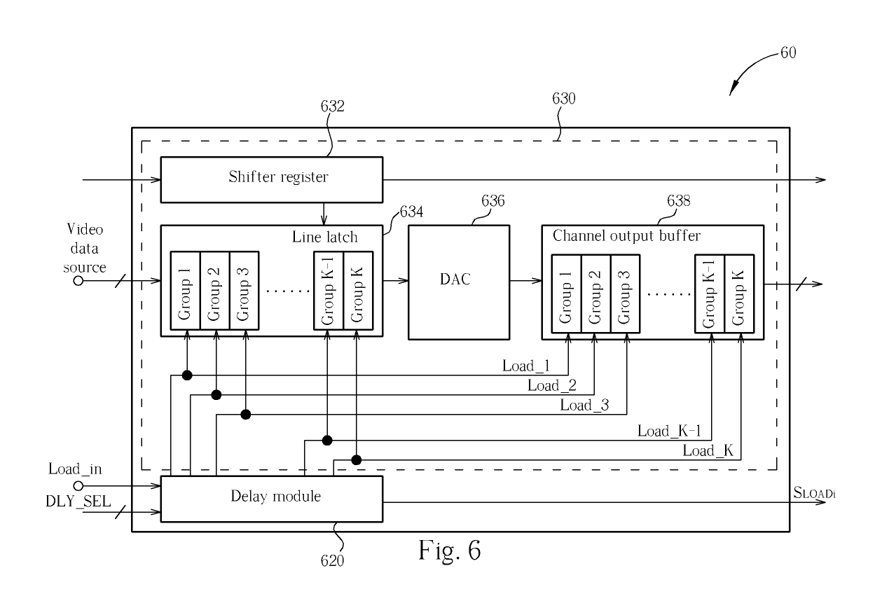

Regarding application of a large panel size, a column driver may be responsible for hundreds of output channels and the outputs channels can be divided into groups. It may spend too much time that a row-scan signal travels from the first output channel to the last in the column driver, reducing charge efficiency of the TFT cells. In another embodiment of the present invention, the delay controller can generate corresponding delay versions of load signals for the output channel groups. Please refer to FIG. 6, which is a schematic diagram of the column driver 60 according to an embodiment of the present invention. The column driver 60 is utilized to realize each of the column drivers CD₁-CD_{N} shown in FIG. 3, and includes a delay module 620 and a video data processing unit 630. In this case, the column driver 60 are responsible for outputting video data corresponding to multi channels, and therefore the video data is grouped in the column driver 60. Here, assume that each column driver takes in charge of L output channels divided into K groups. The delay module 620 can generate K delay versions of load signals for the output channel groups. The video data processing unit 630 includes a shifter register 632, a line latch 634, a DAC 636 and a channel output buffer 638. The line latch 634 and the channel output buffer 638 also have K divisions to receive the load signals outputted by the delay module 620. Operations of the column drivers in FIG. 6 are similar to those in FIG. 4.

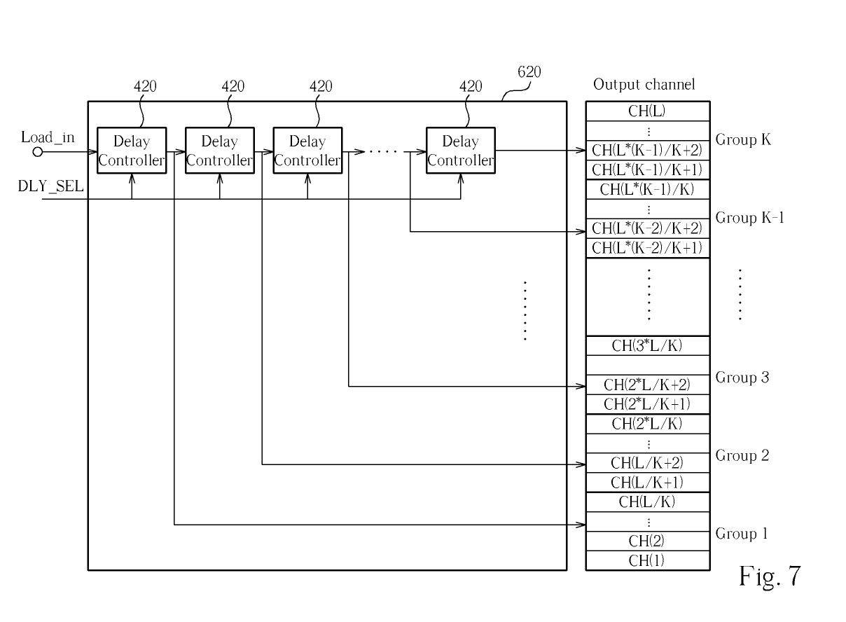

Please refer to FIG. 7, which is a schematic diagram of the delay module 620 according to FIG. 6. The delay module 620 is also an embodiment for the delay modules DE₁-DE_{N} of FIG. 3 and includes a receiving terminal Load_in and K delay controllers 420 in FIG. 5, coupled in cascade. Each delay controller 420 in the delay module 620 determines the predetermined time for the load signal according to the control signal DLY_SEL, and selects an expected delay version of load signal to output to the next delay controller 420 and corresponding divisions of the channel output buffer 638 and the line latch 634. The last delay controller 420 in cascade outputs the load signal to the next column driver besides the multiplexer MUX. In FIG. 7, channel output group 1-K includes L/K channels each. Regarding the column driver CD₁, the channel output group 1 refers to the load signal S_{LOAD01} outputted by the first delay controller 420, whereas the channel output group 2 refers to the load signal S_{LOAD02} outputted by the second delay controller 420, and so do others. Here, the load signal S_{LOAD0Y} represents the load signal which is delayed by time of (Y×the predetermined time÷K, Y=1-K) after received by the receiving terminal Load_in.

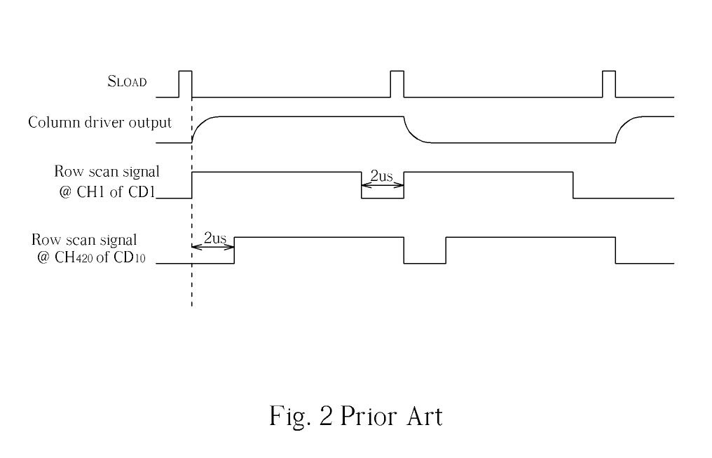

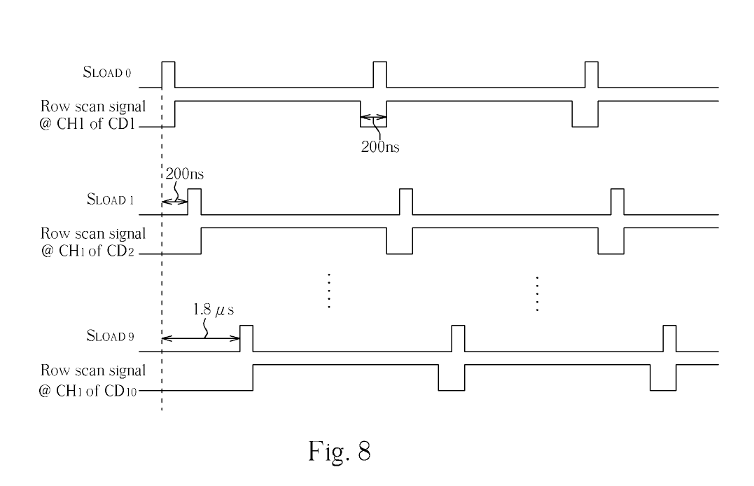

As known from the above, the delay controller 420 in FIG. 5 and the delay module 620 in FIG. 6 determine the predetermined time for the load signal according to the control signal DLY_SEL. The predetermined time is utilized to make timing of the load signal match turning-on time of corresponding TFT cells. Please refer to FIG. 8, which is a timing diagram of signals corresponding to the column drivers and the row drivers according to FIG. 3 and FIG. 4. Some specifications of the display device used for FIG. 8 are identical with those in FIG. 2, and are described as follows. The panel size is 32 inch, display resolution is 1366×768 and the frame rate is 60 frames per second. Each column driver has 420 output channels so that the display device requires ten column drivers, CD₁-CD₁₀. Moreover, each scan line is allowed to be charged for 15 μs to achieve undistorted images, and thereby the row scan signal needs 2 μs to travel from the first output channel of the column driver to the last output channel of the last column driver. From top to bottom, signal timings in FIG. 8 refer to the load signal S_{LOAD}, the row scan signal related to the first output channel CH₁ of the column driver CD₁, the load signal S_{LOAD1}, the row scan signal related to the first output channel CH₁ of the column driver CD₂, . . . , the load signal S_{LOAD9} and the row scan signal related to the first output channel CH₁ of the column driver CD₁₀. The predetermined time is set to be 200 ns, and delay time of the load signal S_{LOAD} is proportional to the number of the column drivers which the load signal S_{LOAD} passes through. As a result, the column driver CD₁ uses the load signal S_{LOAD} outputted by the timing controller. The column driver CD₂ uses the load signal S_{LOAD1} delayed by the column driver CD₁ by 200 ns (2 μs÷10). Similarly, the column driver CD₁₀ uses the load signal S_{LOAD9} delayed by the column driver CD₉ by another 200 ns. In addition, the rising edges of row scan signals exactly fall on the falling edges of corresponding load signals. From the above, timing the load signal S_{LOAD9} is totally delayed by 1.8 μs compared with timing of the load signal S_{LOAD}. Therefore, time used in each row scan signal to turn-off the TFT cells can be reduced to be 200 ns, increasing charge time of the TFT cells effectively and thereby preventing the TFT cells from charging to a wrong voltage level due to insufficient charge time.

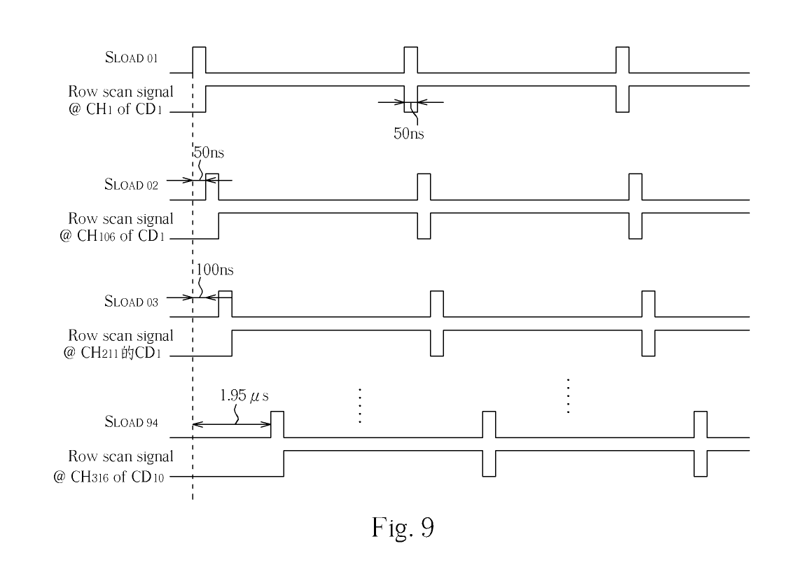

Please refer to FIG. 9, which is a timing diagram of signals corresponding to the column drivers and the row drivers according to FIG. 3 and FIG. 6. The mentioned specifications in FIG. 8 continue to be used in FIG. 9, but each output channel group of the column drivers is further divided into four sub-groups. Thus, each sub-group owns 105 output channels and row scan signal needs 50 ns to travels from one sub-group to another. From top to bottom, the signals shown in FIG. 9 are the load signal S_{LOAD01}, the row scan signal related to the first output channel CH₁ (the first sub-group) of the column driver CD₁, the load signal S_{LOAD02}, the row scan signal related to the 106th output channel CH₁₀₆ (the second sub-group) of the column driver CD₁, the load signal S_{LOAD03}, and the row scan signal related to the 211th output channel CH₂₁₁ (the third sub-group) of the column driver CD₁. By analogizing the above, the bottom are the load signal S_{LOAD94} and the row scan signal related to the first output channel CH₃₁₆ of the column driver CD₁₀ as well as the first output channel of the fourth sub-group of the column driver CD₁₀. The load signal S_{LOAD0} is the load signal S_{LOAD} outputted by the timing controller. Because of the traveling time of 50 ns between two sub-groups, the load signal S_{LOAD02}, corresponding to the 106th output channel CH₁₀₆ of the column driver CD₁, needs to be delayed by 50 ns, compared with the load signal S_{LOAD01}. Similarly, the load signal S_{LOAD03} should be further delayed by 50 ns. As a result, compared with the load signal S_{LOAD01}, the load signal S_{LOAD02}, the load signal S_{LOAD03} and the load signal S_{LOAD94} are delayed by 50 ns, 100 ns and 1.95 μs, respectively. In addition, the rising edges of row scan signals fall on the falling edges of corresponding load signals as well as in FIG. 8. Thus, for each sub-group, turn-off time of the TFT cells can be reduced to be 50 ns for the row scan signals, increasing charge time of the TFT cells corresponding to each sub-groups and thereby preventing the TFT cells from charging to a wrong voltage level due to insufficient charge time. The positive effect can be obviously found in the applications of a large panel size.

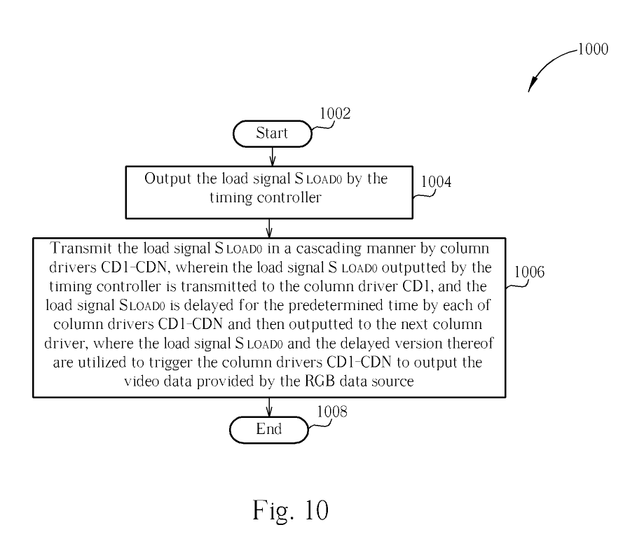

Please refer to FIG. 10, which is a flowchart of a process 1000 according to an embodiment of the present invention. The process 1000 is utilized to realize the display device 30 in FIG. 3 and includes the following steps:

1002:Start.

1004:Output the load signal S_{LOAD0} by the timing controller 310.

1006:Transmit the load signal S_{LOAD0} in a cascading manner by column drivers CD1-CDN, wherein the load signal S_{LOAD0} outputted by the timing controller 310 is transmitted to the column driver CD1, and the load signal S_{LOAD0} is delayed for the predetermined time by each of column drivers CD1-CDN and then outputted to the next column driver, where the load signal S_{LOAD0} and the delayed version thereof are utilized to trigger the column drivers CD1-CDN to output the video data provided by the Video data source.

1008: End.

According to the process 1000, the load signal S_{LOAD0} is outputted from the timing controller 310 to the column driver CD₁ and then from the column driver CD₁ to the column driver CD_{N}. Each the column driver delays the load signal S_{LOAD0} for the predetermined time. As for Step 1006, each of the column drivers CD₁-CD_{N} employs multiple delay controllers 420 to realize delay of the load signal S_{LOAD0} according to the control signal DLY_SEL. The video data is processed and then outputted to corresponding pixels, or TFT cells, of the display device 30 according to timing of the load signal S_{LOAD0} outputted by the corresponding delay controller. Alternatively, In the situation that each column driver is responsible for multiple output channels, the load signal S_{LOAD0} is delayed for multiple predetermined times by the delay module 620 of each of the column drivers CD₁-CD_{N}. Therefore, the load signal is transmitted in a cascading manner through the column drivers, and delayed for a specific time to match data output time with turn-on time of the corresponding TFT cells.

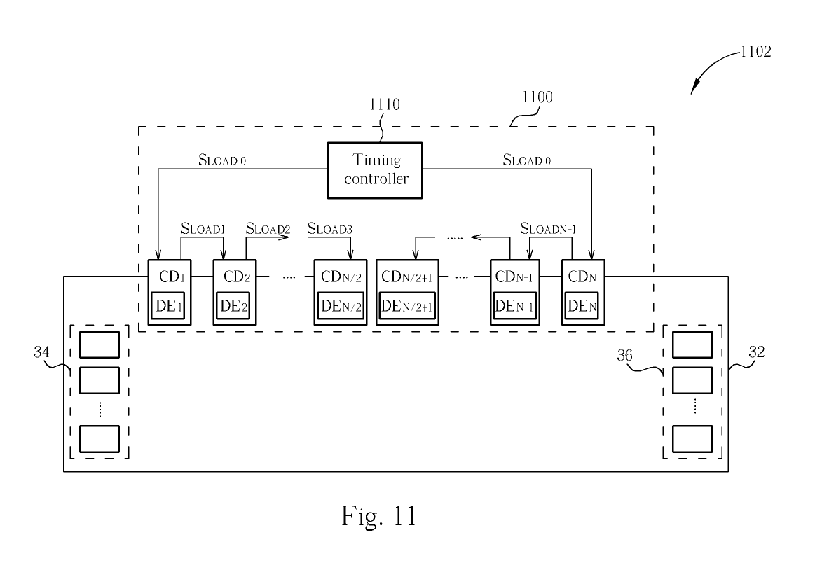

Please note that those skilled in the art can do modification according to internal architecture of the display device. Please refer to FIG. 11, which is a schematic diagram of a driving device 1100 of a display device 1102 according to an embodiment of the present invention. In the display device 1102, the panel 32, the row driver 34 and the column driver CD₁-CD_{N} included in the driving device 1100 are the same as those in FIG. 3. Besides, the display device 1102 includes a timing controller 1110 and multiple row drivers 36 installed in the other side of the panel 32. In FIG. 11, the column drivers CD₁-CD_{N} are divided into two groups. The delay modules DE₁ and DE_{N} simultaneously receive the load signal S_{LOAD0} generated by the timing controller 1110. The load signal S_{LOAD0} is transmitted from the column driver CD₁ to the column driver CD_{N/2}, and the delay modules DE₁-DE_{N/2} perform the above-mentioned delay operation on the load signal S_{LOAD0}. On the other hand, the load signal S_{LOAD0} is transmitted in an opposite direction from the column driver CD_{N} to the column driver CD_{N/2+1}. The two load signals S_{LOAD0} are delayed by both of the delay modules DE₁-DE_{N/2} and DE_{N}-DE_{N/2+1}. As a result, the load signal S_{LOAD0} can match the time the row drivers 36 turn on the TFT cells. Thus, the above embodiment is modified to adopt two cascading transmissions for the load signal according to the arrangement of the row drivers. Those skilled in the art can modify a number of the load signal S_{LOAD0} and transmission direction thereof, conforming to the cascading principle.

In the abovementioned embodiments of the present invention, the control signal DLY_SEL is preferably set by the timing controller 310. Each column driver can receive corresponding control signal DLY_SEL with a pin or through a communications protocol that is established between column drivers CD₁-CD_{N} and the timing controller 310. The control signal DLY_SEL is embedded in the communications protocol.

Please note that the driving device and method for transmitting the load signal in a cascading manner are embodiments of the present invention, but not limitation of the present invention. The timing controller may also output the load signal to the column drivers in a point-to-point or bus-type manner. As for the point-to-point manner, the column drivers independently receive the load signals from the timing controller, while the column drivers share at least a load signal in the bus-type manner. The point-to-point and bus-type interfacing architectures are well known in the art and detailed explanations are omitted herein. When the point-to-point or bus-type manner is applied, the column drivers CD₁-CD₁₀ delay the load signal after receiving the load signal from the timing controller, and do not need to output the delayed load signal to other column drivers. The control signals DLY_SEL used in each column driver are adjusted according to the distance between the column driver and the row driver.

When the point-to-point manner is applied, the delay information can also be generated at the timing controller side. Thus, the delay module 620 of FIG. 7 and the delay module 420 of FIG. 5 can be installed in the timing controller and delay the load signal before the load signal is outputted to the column drivers. The detailed operation of the delay modules has been described and therefore is omitted herein.

In the present invention, the load signal is provided with delay information generated at the column driver side or the timing controller side. Thus, the load signal can easily cooperate with row scan signal and the TFT cells do not need to sacrifice the charge time. Regarding the signal timing in the above embodiment of the present invention, the TFT cells must be turned off for at least the period the row scan signal needs to travel the scan line. The driving device of the present invention uses different delay versions of the load signal for each column driver or the output channel group, reducing turn-off time of the TFT cells effectively. Therefore, the present invention can earn more charge time for the TFT cells.

Those skilled in the art will readily observe that numerous modifications and alterations of the device and method may be made while retaining the teachings of the invention.

What is claimed is:

1. A driving device of a display device, the driving device comprising:
a timing controller for outputting at least a load signal;
a column driver module coupled to the timing controller; and
at least a delay module for delaying the load signal for a predetermined time;
wherein the load signal is utilized to trigger the plurality of column drivers to output video data provided by a video data source and the video data corresponds to pixels on a panel of the display device.

2. The driving device of claim 1, wherein the column driver module comprises a plurality of column drivers.

3. The driving device of claim 2, wherein the delay module is installed in the plurality of column drivers, and the timing controller outputs the load signal to the most preceding one of the plurality of column drivers, and the plurality of column drivers transmits the load signal with delay time in a cascading manner, where the delay time is generated by the corresponding delay module.

4. The driving device of claim 3, wherein the most preceding one of the plurality of column drivers has a shorter distance from a plurality of row drivers than the other ones of the plurality of column drivers do, where the plurality of row drivers are arranged in a line.

5. The driving device of claim 2, wherein the timing controller outputs the load signal to the plurality of column drivers in a point-to-point manner.

6. The driving device of claim 5, wherein the delay module is installed in the plurality of column drivers or in the timing controller.

7. The driving device of claim 2, wherein the timing controller outputs the load signal to the plurality of column drivers in a bus-type manner.

8. The driving device of claim 7, wherein the delay module is installed in the plurality of column drivers.

9. The driving device of claim 1, wherein the column driver module is a column driver.

10. The driving device of claim 9, wherein the delay module is installed in the plurality of column drivers or in the timing controller.

11. The driving device of claim 1, wherein the column driver module comprises at least a column driver and the column driver comprises a video data processing unit coupled to the delay module, for processing the video data and then outputting the processed video data to the pixels according to timing of the load signal delayed by the delay module.

12. The driving device of claim 11, wherein the video data processing unit comprises:
a shifter register coupled to the timing controller, for receiving a startup signal generated by the timing controller;
a line latch coupled to the shifter register, the delay module and the video data source, for latching the video data provided by the video data source according to timing of a signal outputted by the shifter register and timing of the load signal outputted by the delay module;
a digital-to-analog converter (DAC) coupled to the line latch, for converting signals outputted by the line latch from digital into analog form; and
a channel output buffer coupled to the digital-to-analog converter and the delay module, for outputting analog video data according to the timing of the load signal outputted by the delay module.

13. The driving device of claim 1, wherein the delay module comprises:
a receiving terminal for receiving the load signal;
a plurality of delay units coupled in cascade, for delaying timing of the received load signal; and
a multiplexer coupled to the receiving terminal and an output terminal of each of the plurality of delay units, for determining the predetermined time according to a control signal.

14. The driving device of claim 1, wherein the delay module comprises a plurality of delay controllers for delaying timing of the received load signal for a plurality of predetermined times according to a control signal and thereby outputting a plurality of delayed load signals, where each delay controller comprises:
a receiving terminal for receiving the load signal;
a plurality of delay units coupled in cascade, for delaying timing of the load signal; and
a multiplexer coupled to the receiving terminal and an output terminal of each of the plurality of delay units, for determining the plurality of predetermined times according to a control signal.

15. The driving device of claim 1, wherein the predetermined time corresponds to timing of signals outputted by a row driver of the display device.

16. The driving device of claim 1, wherein the display device is a flat-panel display.

17. A driving method for a display device, the driving method comprising:
transmitting at least a load signal from a timing controller to a column driver module; and
delaying the load signal for a predetermined time;
wherein the load signal is utilized to trigger the plurality of column drivers to output video data provided by a video data source and the video data corresponds to pixels on a panel of the display device.

18. The driving method of claim 17, wherein the column driver module comprises a plurality of column drivers.

19. The driving method of claim 18, wherein outputting the load signal from the timing controller to the column driver module comprises outputting the load signal by the timing controller only to the most preceding one of the plurality of column drivers.

20. The driving method of claim 19 further comprising transmitting the load signal through the plurality of column drivers in a cascading manner.

21. The driving method of claim 20, wherein delaying the load signal for the predetermined time comprises delaying the load signal for the predetermined time by the plurality of column drivers during the cascaded transmission.

22. The driving method of claim 18, wherein outputting the load signal from the timing controller to the column driver module comprises outputting the load signal to the plurality of column drivers in a bus-type manner.

23. The driving method of claim 18, wherein delaying the load signal for the predetermined time comprises delaying the load signal for the predetermined time by the plurality of column drivers.

24. The driving method of claim 18, wherein outputting the load signal from the timing controller to the column driver module comprises outputting the load signal to the plurality of column drivers in point -to-point manner.

25. The driving method of claim 18, wherein delaying the load signal for the predetermined time comprises delaying the load signal for the predetermined time by the plurality of column drivers or by the timing controller.

26. The driving method of claim 17, wherein the column driver module comprises a column driver.

27. The driving method of claim 26, wherein delaying the load signal for the predetermined time comprises delaying the load signal for the predetermined time by the column drivers or by the timing controller.

28. The driving method of claim 17 further comprising processing the video data and then outputting the processed video data according to timing of the load signal which is delayed.

29. The driving method of claim 17, wherein delaying the load signal for the predetermined time comprises:
delaying the load signal to generate a plurality of delayed signals corresponding to a plurality of delay times;
selecting a delayed signal, corresponding to the predetermined time, from the plurality of delayed signals according to a control signal.

30. The driving method of claim 17, wherein the predetermined time corresponds to timing of signals outputted by a row driver of the display device.

31. A column driver for a display device, the column driver comprising:
an input terminal for receiving a load signal;
a delay module coupled to the input terminal, for delaying the load signal for a predetermined time; and
a video data processing unit coupled to the delay module, for processing video data, provided by a video data source, and outputting the processed video data to pixels on a panel of the display device according to timing of the load signal outputted from the delay module;
wherein the load signal is utilized to trigger the column driver to output the video data.

32. The column driver of claim 31, wherein the delay module comprises:
a receiving terminal for receiving the load signal;
a plurality of delay units coupled in cascade, for delaying timing of the load signal; and
a multiplexer coupled to the receiving terminal and an output terminal of each of the plurality of delay units, for determining the predetermined time according to a control signal.

33. The column driver of claim 31, wherein the delay module comprises a plurality of delay controllers for delaying timing of the received load signal for a plurality of predetermined times according to a control signal, and each of the plurality of delay controllers comprises:
a receiving terminal for receiving the load signal;
a plurality of delay units coupled in cascade, for delaying timing of the load signal; and
a multiplexer coupled to the receiving terminal and an output terminal of each of the plurality of delay units, for determining the plurality of predetermined times according to a control signal.

34. The column driver of claim 31, wherein the video data processing unit comprising:
a shifter register for receiving a startup signal;
a line latch coupled to the shifter register, the delay module and the video data source, for latching the video data provided by the video data source according to timing of a signal outputted by the shifter register and timing of the load signal outputted by the delay module;
a digital-to-analog converter (DAC) coupled to the line latch, for converting signals outputted by the line latch from digital into analog form; and
a channel output buffer coupled to the digital-to-analog converter and the delay module, for outputting analog video data according to timing of the load signal outputted by the delay module.

35. A timing controller of a display device, the timing controller comprising:
at least a delay module for delaying at least a load signal for a predetermined time; and
an output unit for outputting the delayed load signal to at least a column driver;
wherein the load signal is utilized to trigger the column driver to output the video data.

36. The timing controller of claim 35, wherein the delay module comprises:
a receiving terminal for receiving the load signal;
a plurality of delay units coupled in cascade, for delaying timing of the load signal; and
a multiplexer coupled to the receiving terminal and an output terminal of each of the plurality of delay units, for determining the predetermined time according to a control signal.

37. The timing controller of claim 35, wherein the delay module comprises a plurality of delay controllers for delaying timing of the received load signal for a plurality of predetermined times according to a control signal, and each of the plurality of delay controllers comprises:
a receiving terminal for receiving the load signal;
a plurality of delay units coupled in cascade, for delaying timing of the load signal; and
a multiplexer coupled to the receiving terminal and an output terminal of each of the plurality of delay units, for determining the plurality of predetermined times according to a control signal.
